(19) United States
(12) Patent Application Publication
(10) Pub. No.: US 2014/0183994 A1
(43) Pub. Date: Jul. 3, 2014

(54) HOUSING CORE INDUCTOR AND MOTOR ASSEMBLY USING THE SAME

(71) Applicant: SAMSUNG ELECTRO-MECHANICS CO., LTD., Suwon-si (KR)

(72) Inventors: Hyung Joon Kim, Suwon-si (KR); Dae Sung Kim, Suwon-si (KR); Kwang Hyun Lee, Suwon-si (KR); Han Kyung Bae, Suwon-si (KR); Hong Chul Shin, Suwon-si (KR)

(73) Assignee: SAMSUNG ELECTRO-MECHANICS CO., LTD., Suwon-si (KR)

(21) Appl. No.: 14/141,893

(22) Filed: Dec. 27, 2013

(30) Foreign Application Priority Data
Dec. 28, 2012 (KR) 10-2012-0157095

(51) Int. Cl. H02K 11/02

(52) U.S. Cl. CPC H02K 11/024
USPC 310/72

(57) ABSTRACT

Disclosed herein are a housing core inductor and a motor assembly using the same. The housing core inductor includes: a housing core formed by stacking a plurality of plate bodies on a lower surface of a housing body of a housing of a motor assembly, each of the plurality of plate bodies including a central portion provided with a through-hole through which a shaft penetrates and a plurality of arms extended from the central portion in a radial direction to form a plurality of space parts; and a coil wound around the plurality of arms of the housing core.

### CROSS REFERENCE TO RELATED APPLICATION

This application claims the benefit of Korean Patent Application No. 10-2012-0157095, filed on Dec. 28, 2012, entitled “Housing Core Inductor and Motor Assembly”, which is hereby incorporated by reference in its entirety into this application.

### BACKGROUND OF THE INVENTION

1. Technical Field

The present invention relates to a housing core inductor and a motor assembly using the same.

2. Description of the Related Art

A switched reluctance motor (SRM) is one of the old motors that have been used over 150 years. This traditional type of reluctance motor has been known as the switched reluctance motor in order to satisfy a condition of a variable drive in accordance with the development of a power semiconductor.

“Switched Reluctance” was named by S.A. Nasar and has described two main features of the SRM.

First, ‘Switched’ means that a motor should always be operated in a continuous switching mode. This term has been used after applying a new type of power semiconductor in accordance with development and advance of the new type of power semiconductor.

Second, ‘Reluctance’ means a double salient pole type structure in which a rotor and a stator are operated by varying a reluctance magnetic circuit.

Scholars such as Nasar, French, Koch, and Lawrenson have devised a continuous mode control using a power semiconductor unlike a structurally similar stepping motor, in the 1960s.

At that time, since only a power thyristor semiconductor has a function of controlling a relatively high voltage and current, it has been used to control the switched reluctance motor.

At the present time, a power transistor, a gate turn-off thyristor (GTO), an insulated gate bipolar mode transistor IGBT, a power metal oxide semiconductor field effect transistor (MOSFET), and the like, have been developed and variously used in a rated power range for controlling the SRM.

The SRM has a very simple structure. The SRM does not include a permanent magnet, a brush, and a commutator. In this SRM, a stator includes salient poles and has a structure in which steel sheets are stacked, and windings around which coils connected in series with each other are wound are independently connected to the respective phases and enclose stator poles.

A rotor does not include a winding, has a structure in which steel sheets are stacked, and includes salient poles, similar to the stator. Therefore, since both of the stator and the rotor have the salient pole structure, the SRM may be considered as having a double salient pole type structure.

Due to this simple structure, reliability is increased and a production cost is decreased, such that it is likely that the SRM will substitute for a variable speed drive.

The SRM having the above-mentioned advantage has been currently used in various fields. Particularly, the SRM has been commercialized in a vacuum cleaner.

Meanwhile, several organizations have recently demanded to necessarily add a power factor compensating and electromagnetic interference (EMI)/electromagnetic capability (EMC) protecting circuit in all home appliances as well as a cleaner all over the world.

However, an inductor, which is one of the components configuring the power factor compensating and EMI/EMC protecting circuit, has a large volume and requires an additional component for heat radiation, which are problematic.

[Prior Art Document]

[Patent Document]

(Patent Document 1) Japanese Patent Laid-Open Publication No. 1995-87712

### SUMMARY OF THE INVENTION

The present invention has been made in an effort to provide a housing core inductor capable of having a decreased volume and facilitating heat radiation by being manufactured using a motor housing, and a motor assembly using the same.

According to a preferred embodiment of the present invention, there is provided a housing core inductor including: a housing core formed by stacking a plurality of plate bodies on a lower surface of a housing body of a housing of a motor assembly, each of the plurality of plate bodies including a central portion provided with a through-hole through which a shaft penetrates and a plurality of arms extended from the central portion in a radial direction to form a plurality of space parts; and a coil wound around the plurality of arms of the housing core.

The plate body of the housing core may be formed in a cross shape by the plurality of arms extended in the central portion in the radial direction.

The plate body of the housing core may further include a plurality of connection rings connecting outer sides of the plurality of arms extended from the central portion in the radial direction to each other.

The housing may include fixing parts extended in a via shape from one side thereof toward the housing core, and the housing core may include fixing holes formed at one side thereof and having the fixing parts inserted thereinto.

A plurality of fixing parts may be formed, and one of the plurality of fixing parts may be formed to have a length longer than those of the others thereof.

The housing may further include dampers mounted on the fixing parts, absorbing impact, and made of an elastic material.

As the housing core, any one of a dust core, a laminated core, and a ferrite core may be used.

The coil may be wound from an outer side of the aim toward the central portion.

According to another preferred embodiment of the present invention, there is provided a motor assembly including: a shaft forming the center of rotation of a motor; a motor unit including a rotor and a stator so as to rotate the shaft; an impeller coupled to an upper portion of the shaft so as to suck air through a sucking port formed in a cover; a diffuser guiding the air sucked by the impeller to an inner portion of the motor; a housing including the motor unit and formed to enclose an outer circumference of the shaft; and a housing core inductor including a housing core formed by stacking a plurality of plate bodies on a lower surface of a housing body of the housing of the motor assembly, each of the plurality of plate bodies including a central portion provided with a through-hole through which the shaft penetrates and a plurality of arms extended from the central portion in a radial direction to form a plurality of space parts, and a coil wound around the plurality of arms of the housing core.

The motor assembly may further include: an upper insulator installed on an upper surface of the motor unit; and a lower insulator installed on a lower surface of the motor unit.

The plate body of the housing core may be formed in a cross shape by the plurality of arms extended in the central portion in the radial direction.

The plate body of the housing core may further include a plurality of connection rings connecting outer sides of the plurality of arms extended from the central portion in the radial direction to each other.

The housing may include fixing parts extended in a via shape from one side thereof toward the housing core, and the housing core may include fixing holes formed at one side thereof and having the fixing parts inserted thereinto.

A plurality of fixing parts may be formed, and one of the plurality of fixing parts may be formed to have a length longer than those of the others thereof.

The housing may further include dampers mounted on the fixing parts, absorbing impact, and made of an elastic material.

As the housing core, any one of a dust core, a laminated core, and a ferrite core may be used.

The coil may be wound from an outer side of the arm toward the central portion.

The motor assembly may further include: a sensor magnet installed on a lower surface of a lower balancing member of the motor unit; and a hall sensor installed on a lower surface of the sensor magnet.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will be more clearly understood from the following detailed description taken in conjunction with the accompanying drawings, in which:

FIG. 1 is a cross-sectional perspective view of a switched reluctance motor assembly according to a preferred embodiment of the present invention;

FIG. 2 is an exploded perspective view showing that a motor housing inductor according to the preferred embodiment of the present invention is installed at a motor unit;

FIG. 3 is a partial exploded perspective view showing that a damper is installed on a fixing part of a housing;

FIG. 4 is a plan view of the motor housing inductor;

FIG. 5 is a view showing a magnetic flux flow of the motor housing inductor; and

FIGS. 6 and 7 are simulation diagrams of the motor housing inductor.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “Tint”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

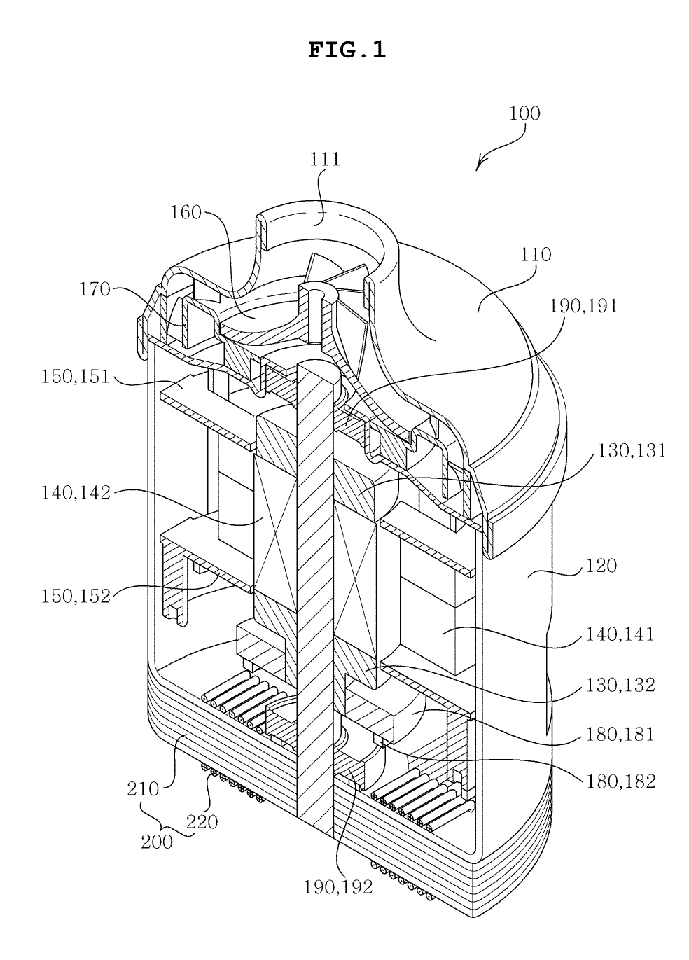

FIG. 1 is a cross-sectional perspective view of a switched reluctance motor assembly according to a preferred embodiment of the present invention.

As shown in FIG. 1, the switched reluctance motor assembly 100 according to the preferred embodiment of the present invention is configured to include an impeller 160 and a diffuser 170 sucking air through a sucking port 111 formed in a cover and transferring the sucked air; a housing 120 having a motor unit mounted therein, the motor unit 140 rotating a shaft S operating together with the impeller 160; an insulator 150 installed on and beneath the motor unit 140; and a motor housing inductor 200 including an inductor core 210 installed on a bottom surface of the housing 120 and a coil 220 wound around the inductor core 210.

Here, the impeller 160 is installed at an inner side of the cover 110 having the sucking port 111 formed at an upper end thereof and is installed at an inner side of the housing 120 connected to a lower end of the cover 110 so as to be rotated by the shaft S.

In addition, the diffuser 170 is disposed between the impeller 160 and the motor unit 140 and transfers air discharged through an outlet part of the impeller 160.

Here, the impeller 160 and the diffuser 170 are installed while having a predetermined interval therebetween so that the air is sucked through the sucking port 111 by rotation of the impeller 160, passes through the impeller 160, and is then transferred by the diffuser 170, such that pressure thereof is increased.

The housing 120 is installed at the lower end of the cover 110 in which the sucking port 111 is formed.

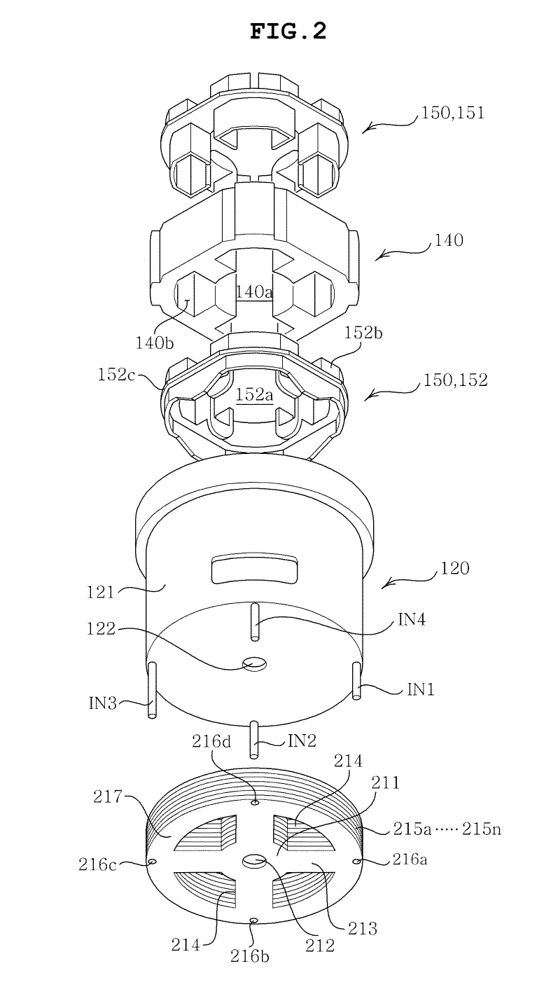

Meanwhile, the housing 120 may include a housing body 121 having a cylindrical shape and having a through-hole 122 formed at the center thereof, the through-hole 122 having the shaft S penetrating therethrough; and fixing parts IN extended in a via shape from one side of the housing body 121 toward the motor housing inductor 200, as shown in FIG. 2.

The motor housing inductor 200 includes a housing core 210 formed by stacking a plurality of plate bodies 215a to 215n including a central portion 211 provided with a through-hole 212 through which the shaft S penetrates and a plurality of anus 213 extended from the central portion in a radial direction to form a plurality of space parts 214 in which the coil 220 is wound; and the coil 220 wound around the housing core 210.

As the housing core 210, a dust core formed by compressing and molding ferromagnetic powders such as iron, a laminated core formed by laminating steel plates such as silicon steel, or a ferrite core is used

In addition, the plate body 215 of the housing core 210 is formed in a cross shape by the plurality of arms 213 extended in the central portion 211 in the radial direction. The housing core 210 may include fixing holes 216 formed at one side thereof and having the fixing parts IN inserted thereinto.

That is, the fixing parts IN extended from the housing 120 in a downward direction (toward the motor inductor core) in FIG. 2 are inserted into the fixing holes 216, such that the housing 120 and the housing core 210 may be fixed to each other.

Here, the fixing parts IN may include four fixing parts IN1, IN2, IN3, and IN4, and the fixing holes 216 may also include four fixing holes 216a, 216b, 216c, and 216d corresponding thereto.

Meanwhile, as shown in FIG. 2, a plurality of fixing parts IN may be formed, and one of the plurality of fixing parts IN may be formed to have a length longer than those of the others thereof. This is to easily assemble the housing 120 and the housing core 210 to each other by adjusting a height of a step at the time of assembling them to each other. When the fixing part having the long length is first inserted into the fixing hole 216, positions of the other fixing parts are adjusted so that the other fixing parts may be automatically inserted into the other fixing holes 216, thereby further facilitating the assembling. For example, after the fixing part IN3 positioned at a lower end of the left in FIG. 2 is formed to have a length longer than those of the other fixing parts IN1, IN2, and IN4 and is inserted into the fixing hole 216, the other fixing parts IN1, IN2, and IN4 are inserted into and fixed to the other fixing holes.

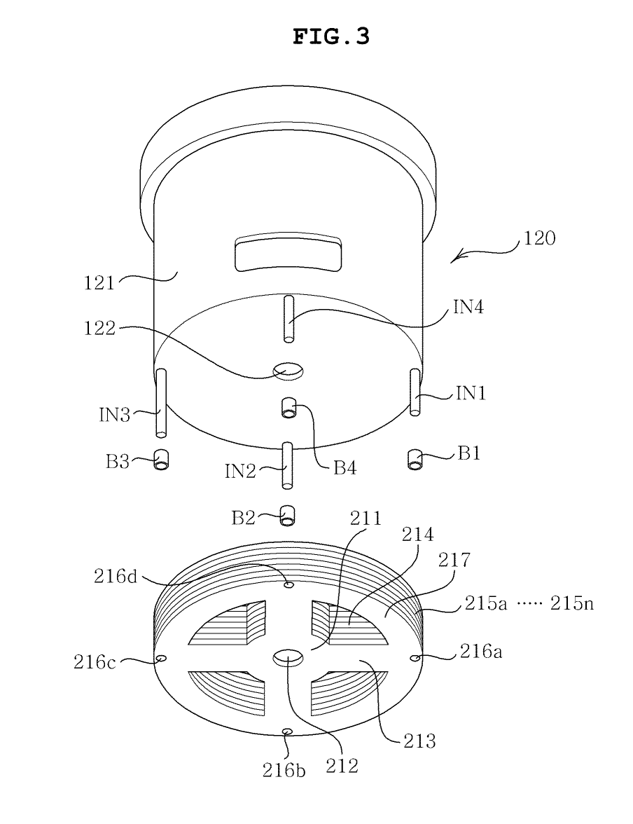

Meanwhile, as shown in FIG. 3, the housing 120 may further include dampers B mounted on the fixing parts IN, absorbing impact, and made of an elastic material. That is, as shown in FIG. 3, the dampers B1, B2, B3, and B4 may be installed on the four fixing parts IN, respectively, to absorb impact or vibration generated inside or outside the housing 120. As a material of the to damper B, any material having elasticity, such as rubber, or the like, may be used Here, the damper B has a hollow shape, such that the fixing part IN may penetrate therethrough. Further, in the damper B, a surface (an upper surface in FIG. 3) into which the fixing part IN is inserted is opened, and a lower surface is not opened, such that the fixing part IN may be inserted into and received in the damper B.

In addition, the housing core 210 further includes a plurality of connection rings 217 connecting outer sides of the plurality of arms 213 extended from the central portion 211 in the radial direction to each other.

The coil 220 is wound around the arm of the housing core 210 in a direction from the outside toward the central portion 211, such that it passes through the shortest distance when it is wound around a neighboring arm.

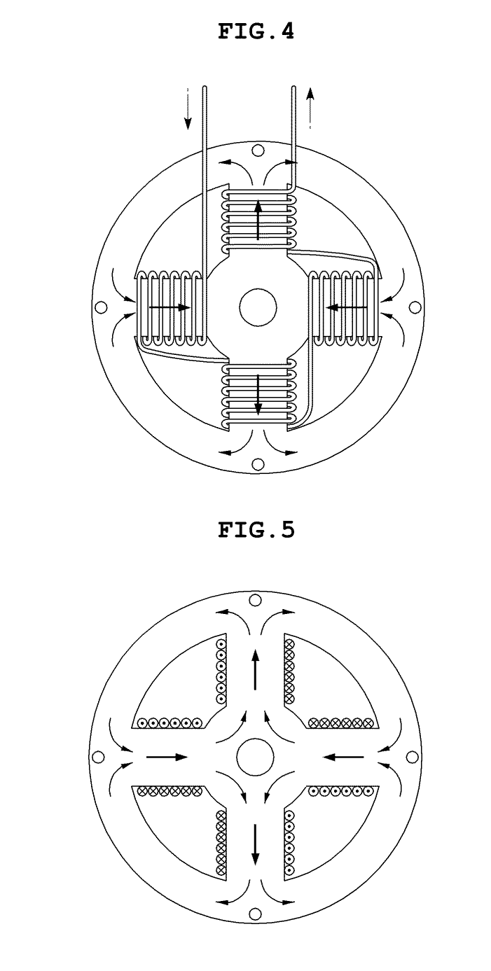

That is, referring to FIG. 4, which is a plan view of the housing core inductor 200, the coil is wound from the outside of the housing core 210 toward the central portion 211 so that magnetic fluxes flow inwardly in two anus facing each other and flow outwardly in the other two anus facing each other as shown in a view showing a magnetic flux flow of FIG. 5, thereby making it possible to obtain a smooth magnetic flux flow.

Meanwhile, the insulator 150 for insulation from the coil wound around the stator 141 may be installed on and beneath of the motor unit 140.

The insulator 150 may include an upper insulator 151 installed on an upper surface of the motor unit 140 and a lower insulator 152 installed on a lower surface of the motor unit 140.

That is, the insulator 150 may be installed on the upper and lower surfaces of the motor unit 140, respectively, in order to stably secure insulation performance of the motor unit 140. Meanwhile, the lower insulator 152 may have a plate body shape as shown in FIG. 2 and include a lower insulator body 152c having a through-hole 152a formed at the center thereof, the through-hole 152a having the shaft S penetrating therethrough.

In addition, the lower insulator 152 may include insertion protrusions 152b protruding upwardly from the lower insulator body 152c and inserted into space parts 141b of the stator 141, as shown in FIG. 2. The insertion protrusion parts 152b may have a wall body shape, be formed to be spaced apart from each other, and be inserted into four space parts 141b, respectively, as shown in FIG. 2.

The space part 141b of the stator 141 is an empty space between the winding coils (not shown) wound around neighboring stator parts as well known. Therefore, a detailed description thereof will be omitted.

As shown in FIG. 1, the switched reluctance motor assembly 100 may also include a rotor electrode sensing device 180 including a sensor magnet 181 installed on a lower surface of a lower balancing member 132 of the motor unit 140 and a hall sensor 182 installed on the sensor magnet 181. As well known, it is required to sense electrodes of a rotor 142 in order to control the switched reluctance motor. To this end, the switched reluctance motor assembly includes the sensor magnet 181 and the hall sensor 182 as described above.

An operation of sucking air by the switched reluctance motor assembly 100 according to the preferred embodiment of the present invention as described above will be described with reference to FIG. 1.

First, as described above, the shaft S is rotated by the motor unit 140, and the impeller 160 is rotated by the rotated shaft S. The air is sucked through the sucking port 111 by the rotated impeller 160 and is transferred by the diffuser 170. Here, the shaft S may be supported by bearings 190: 191 and 192 installed in a vertical direction as shown in FIG. 1. Meanwhile, balancing members 130: 131 and 132 may be installed on or beneath the motor unit 140.

The motor unit 140 is controlled by a controller (not shown). In this case, the controller performs a control so that a rotation speed of the impeller 160 arrives at an optimal state. The control of the controller is performed by controlling an inverter driving the motor. In this case, as power required for the inverter, power converted into direct current (DC) power by an alternating current (AC) to DC rectifier, stored in the motor housing inductor 200, and supplied from the motor housing inductor 200 is used.

Here, the motor housing inductor 200 is installed at a lower end of the housing 120 and is cooled by the air discharged by the impeller.

As set forth above, according to the preferred embodiment of the present invention, the inductor is manufactured using the motor housing, thereby making it possible to decrease a volume of the motor.

In addition, according to the preferred embodiment of the present invention, the air discharged from the motor directly passes through the coil and the core, thereby making it possible to obtain a sufficient heat radiation effect without requiring an additional heat radiation device.

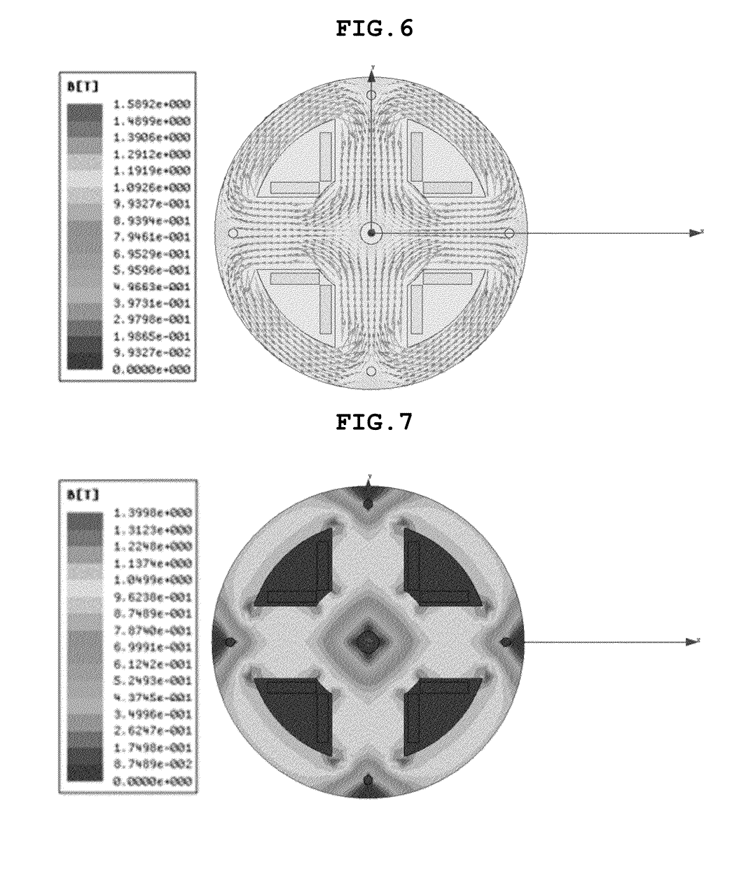

FIGS. 6 and 7 are magnetic simulation diagrams of the motor housing inductor. As shown in FIGS. 6 and 7, magnetic fluxes smoothly flow through the arms of the motor housing inductor, such that desired inductor characteristics may be obtained.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A housing core inductor comprising:
a housing core formed by stacking a plurality of plate bodies on a lower surface of a housing body of a housing of a motor assembly, each of the plurality of plate bodies including a central portion provided with a through-hole through which a shaft penetrates and a plurality of arms extended from the central portion in a radial direction to form a plurality of space parts; and
a coil wound around the plurality of arms of the housing core.

2. The housing core inductor as set forth in claim 1, wherein the plate body of the housing core is formed in a cross shape by the plurality of arms extended in the central portion in the radial direction.

3. The housing core inductor as set forth in claim 2, wherein the plate body of the housing core further includes a plurality of connection rings connecting outer sides of the plurality of arms extended from the central portion in the radial direction to each other.

4. The housing core inductor as set forth in claim 1, wherein the housing includes fixing parts extended in a via shape from one side thereof toward the housing core, and the housing core includes fixing holes formed at one side thereof and having the fixing parts inserted thereinto.

5. The housing core inductor as set forth in claim 4, wherein a plurality of fixing parts are formed, and one of the plurality of fixing parts is formed to have a length longer than those of the others thereof

6. The housing core inductor as set forth in claim 4, wherein the housing further includes dampers mounted on the fixing parts, absorbing impact, and made of an elastic material.

7. The housing core inductor as set forth in claim 1, wherein as the housing core, any one of a dust core, a laminated core, and a ferrite core is used.

8. The housing core inductor as set forth in claim 1, wherein the coil is wound from an outer side of the arm toward the central portion.

9. A motor assembly comprising:
a shaft forming the center of rotation of a motor;
a motor unit including a rotor and a stator so as to rotate the shaft;
an impeller coupled to an upper portion of the shaft so as to suck air through a sucking port formed in a cover;
a diffuser guiding the air sucked by the impeller to an inner portion of the motor;
a housing including the motor unit and formed to enclose an outer circumference of the shaft; and
a housing core inductor including a housing core formed by stacking a plurality of plate bodies on a lower surface of a housing body of the housing of the motor assembly, each of the plurality of plate bodies including a central portion provided with a through-hole through which the shaft penetrates and a plurality of arms extended from the central portion in a radial direction to form a plurality of space parts, and a coil wound around the plurality of arms of the housing core.

10. The motor assembly as set forth in claim 9, further comprising:
an upper insulator installed on an upper surface of the motor unit; and
a lower insulator installed on a lower surface of the motor unit.

11. The motor assembly as set forth in claim 9, wherein the plate body of the housing core is formed in a cross shape by the plurality of arms extended in the central portion in the radial direction.

12. The motor assembly as set forth in claim 11, wherein the plate body of the housing core further includes a plurality of connection rings connecting outer sides of the plurality of arms extended from the central portion in the radial direction to each other.

13. The motor assembly as set forth in claim 9, wherein the housing includes fixing parts extended in a via shape from one side thereof toward the housing core, and
the housing core includes fixing holes formed at one side thereof and having the fixing parts inserted thereinto.

14. The motor assembly as set forth in claim 13, wherein plurality of fixing parts are formed, and one of the plurality of fixing parts is formed to have a length longer than those of the others thereof

15. The motor assembly as set forth in claim 13, wherein the housing further includes dampers mounted on the fixing parts, absorbing impact, and made of an elastic material.

16. The motor assembly as set forth in claim 9, wherein as the housing core, any one of a dust core, a laminated core, and a ferrite core is used.

17. The motor assembly as set forth in claim 9, wherein the coil is wound from an outer side of the arm toward the central portion.

18. The motor assembly as set forth in claim 9, further comprising:
a sensor magnet installed on a lower surface of a lower balancing member of the motor unit; and
a hall sensor installed on a lower surface of the sensor magnet.
